(19) United States
(12) Patent Application Publication
(10) Pub. No.: US 2026/0067104 A1
(43) Pub. Date: Mar. 5, 2026

(54) PHYSICAL UNCLONABLE FUNCTION DEVICE AND METHOD OF GENERATING SAME

(71) Applicants: HYUNDAI MOTOR COMPANY, Seoul (KR); KIA CORPORATION, Seoul (KR); POSTECH Research and Business Development Foundation, Pohang-si (KR)

(72) Inventors: Ji-Sung Lee, Hwaseong-si (KR); Su-Jung Noh, Hwaseong-si (KR); Young-Chan Kim, Hwaseong-si (KR); Han-Saem Lee, Hwaseong-si (KR); Joon-Hyun Kwon, Hwaseong-si (KR); Jang-Seop Lee, Pohang-si (KR); Dong-Min Kim, Pohang-si (KR); Hyun-Sang Hwang, Daegu (KR)

(73) Assignees: HYUNDAI MOTOR COMPANY, Seoul (KR); KIA CORPORATION, Seoul (KR); POSTECH Research and Business Development Foundation, Pohang-si (KR)

(21) Appl. No.: 19/002,085

(22) Filed: Dec. 26, 2024

(30) Foreign Application Priority Data
Sep. 2, 2024 (KR) 10-2024-0118442

(51) Int. Cl. H04L 9/32

(52) U.S. Cl. CPC H04L 9/3278

(57) ABSTRACT

Disclosed is a physical unclonable function (PUF) device, including a plurality of devices having an Ovonic Threshold Switch (OTS) material disposed between a first electrode and a second electrode, wherein the plurality of devices are formed in a cross-bar array structure. When an identical write pulse is applied to the plurality of devices, a state in which each device has a relatively high threshold voltage value or a relatively low threshold voltage value is randomly generated. The present disclosure simplifies the complex semiconductor process technology and circuitry of a conventional PUF device to implement an ultra-high density device, and implements a PUF device utilizing a chalcogenide-based switching material with high reliability and durability.

### CROSS-REFERENCE TO RELATED APPLICATION

This application claims priority to Korean Patent Application No. 10-2024-0118442, filed on Sep. 2, 2024, which is incorporated herein by reference in its entirety.

### BACKGROUND OF THE DISCLOSURE

### Field of the Disclosure

The present disclosure relates to a security device having a physical unclonable function (PUF) and a method of generating the same.

### Description of Related Art

With advancements in information and communication technologies, such as the Internet of Things (IoT), the mass production of autonomous vehicles is anticipated in the near future. However, the mass anticipated production has raised security concerns regarding autonomous driving systems within the vehicles, particularly in the context of vehicle-to-everything (V2X) communications. In addition, if the autonomous driving systems are not reliably protected from external attacks, they may pose a critical threat to the lives of passengers or pedestrians.

In addition, cases have been reported where in conventional software-based security systems, the outcome of security keys generated through machine learning, and the like is predictable.

A physical unclonable function (PUF) device is a device that acts as a fingerprint for an IoT device and generates its own digital fingerprint rather than relying on externally generated cryptographic information, thereby minimizing security key leakage.

Most conventional PUF devices utilize mismatches occurring during the fabrication process, thereby making reset impossible when a key is leaked externally. In addition, the function is implemented by combining a separate random number generator and storage, resulting in high power consumption and making high integration difficult.

The foregoing description of the related art is intended to assist in understanding the background of the present disclosure, and may include an aspect that is not part of a conventional art known to those having ordinary skill in the art.

### SUMMARY OF THE DISCLOSURE

An objective of the present disclosure is to simplify the complex semiconductor process technology and circuitry of a conventional PUF device to implement an ultra-high density device, and provide a PUF device utilizing a chalcogenide-based switching material with high reliability and durability.

According to an aspect of the present disclosure, there is provided a physical unclonable function (PUF) device, including a plurality of devices having an Ovonic Threshold Switch (OTS) material disposed between a first electrode and a second electrode, wherein the plurality of devices are formed in a cross-bar array structure. When an identical write pulse is applied to the plurality of devices, a state in which each device has a relatively high threshold voltage value or a relatively low threshold voltage value is randomly generated.

In addition, the OTS material is a chalcogenide material. In particular, the OTS material may be a chalcogenide material including selenium (Se).

In addition, the OTS material is at least one material comprising Si—Te—As—Ge—Se, Si—Se—As—Ge, In—Se—As—Ge, Si—In—Se—As—Ge, Se—As—Ge, Ge—Se, B—Se, C—Se, Si—Se, Mg—Se, In—Se, or a combination thereof.

In addition, the OTS material is a compound including sulfur(S), selenium (Se), tellurium (Te), polonium (Po), or a combination thereof.

In addition, when an identical read pulse is applied to the plurality of devices, a device in a state with a relatively high threshold voltage value is turned on, and a device in a state with a relatively low threshold voltage value is turned off.

In this example, the read pulse is a value between the relatively high threshold voltage value and the relatively low threshold voltage value.

In addition, the write pulse is a write voltage in a negative (−) direction.

The greater a Se concentration in the OTS material is, the greater a difference between the relatively high threshold voltage value and the relatively low threshold voltage value is.

In addition, the greater a magnitude of the write pulse is, the greater a difference between the relatively high threshold voltage value and the relatively low threshold voltage value is.

In addition, the greater a width of the write pulse is, the greater a difference between the relatively high threshold voltage value and the relatively low threshold voltage value is.

According to an aspect of the present disclosure, there is provided a method of generating a physical unclonable function (PUF) device including: forming the PUF device in the cross-bar array structure; performing a random write operation by applying an identical write pulse to the array structure; applying a read pulse to the array structure; determining whether the plurality of devices randomly are turned on by the applied read pulse; and generating a PUF security device KEY if the plurality of devices randomly are turned on.

In addition, if it is determined that the plurality of devices are not randomly turned on in said determining whether the plurality of devices randomly are turned on, said performing the random write operation is re-performed.

In this example, in said determining whether the plurality of devices randomly are turned on, the plurality of devices being turned on is determined to be random if 50%±5% of the plurality of devices are turned on.

In addition, in said performing the random write operation, the write pulse is a write voltage in a negative (−) direction.

The OTS material is a chalcogenide material.

In addition, the OTS material is a compound including sulfur(S), selenium (Se), tellurium (Te), polonium (Po), or a combination thereof.

The OTS device is characterized in that the threshold voltage varies in subsequent operations depending on the polarity of the applied pulse.

In this case, a random write operation is performed by utilizing the inherent dispersion of the OTS during the write process in the negative direction.

When a write operation is not performed, the OTS has a low threshold voltage, and when a write operation is performed, the OTS has a high threshold voltage.

If a write operation is performed by implementing a cross-bar array with such devices, only some random devices have a high threshold voltage, which the present disclosure may utilize to implement random PUF devices.

### BRIEF DESCRIPTION OF THE DRAWINGS

FIG. 1 shows an example of I-V characteristics of an OTS device according to one embodiment.

FIG. 2 schematically illustrates a PUF device of the present disclosure according to one embodiment.

FIGS. 3 and 4 show a method and operation examples of resistive change and threshold voltage variation in a chalcogenide-based device in response to a write operation according to one embodiment.

FIG. 5 shows a threshold voltage difference between two states depending on the material composition according to one embodiment, and FIG. 6 shows a current at a read voltage according to one embodiment.

FIG. 7 shows a threshold voltage difference between two states depending on the write pulse height according to one embodiment, and FIG. 8 shows a threshold voltage difference between two states depending on the write pulse width according to one embodiment.

FIGS. 9 and 10 show pulse shapes and operation examples for PUF utilization according to one embodiment.

FIG. 11 shows an OTS operation example when a pulse is applied for actual PUF utilization according to one embodiment.

FIG. 12 illustrates a method of generating a PUF device of the present disclosure according to one embodiment.

### DESCRIPTION OF SPECIFIC EMBODIMENTS

In order to fully understand the present disclosure, operational advantages of the present disclosure, and the objectives achieved by the implementation of the present disclosure, reference should be made to the accompanying drawings illustrating embodiments of the present disclosure and the contents described in the accompanying drawings.

In describing embodiments of the present disclosure, known art or a repetitive description that may unnecessarily obscure the gist of the present disclosure has been shortened or omitted.

The present disclosure utilizes a chalcogenide-based switching material to implement a physical unclonable function (PUF) device for security, which enables the self-generation of a random key value by using only a simple circuit, without complex semiconductor process technology.

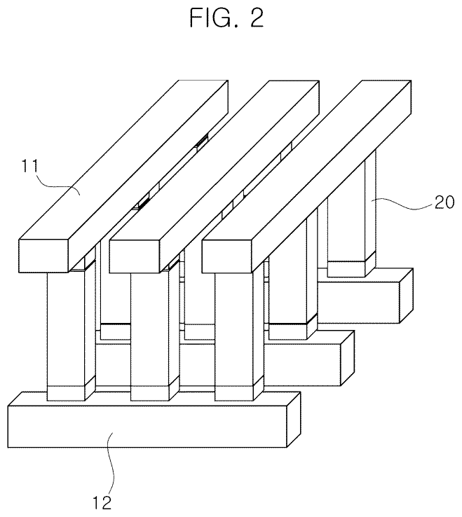

In particular, a PUF device with an ultra-high density cross-point array structure as shown in FIG. 2 is implemented through resistive change, depending on the direction of a write operation, in a chalcogenide-based device.

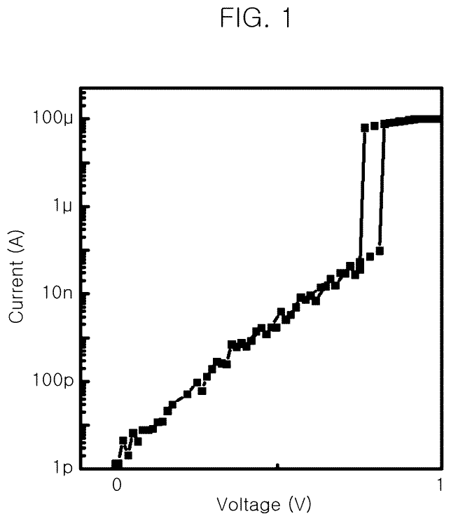

In other words, the PUF device is a device with a structure in which an Ovonic Threshold Switch (OTS) material 20 is disposed between a first electrode 11 and a second electrode 12. In addition, when a voltage is applied from the outside, the resistance state of the device switches to a high-resistance or low-resistance state at a specific voltage as shown in FIG. 1.

The OTS material 20 is a chalcogenide material, which may be a compound including any one of sulfur(S), selenium (Se), tellurium (Te), and polonium (Po).

In embodiments of the present disclosure, a chalcogenide material including Se is used as an example, and specifically, the chalcogenide material may be at least one material comprising Si—Te—As—Ge—Se, Si—Se—As—Ge, In—Se—As—Ge, Si—In—Se—As—Ge, Se—As—Ge, Ge—Se, B—Se, C—Se, Si—Se, Mg—Se, In—Se, or a combination thereof.

The present disclosure aims to implement a PUF device for hardware security by utilizing such a chalcogenide-based switching material.

In the PUF devices of the present disclosure, when an identical write pulse is applied to each of the devices forming a cross-bar array structure as shown in FIG. 2, some of the devices are randomly turned on and enter a state with a high resistance value (i.e., a high threshold voltage value), while the remaining devices are not turned on and enter a state with a low resistance value (i.e., a low threshold voltage value).

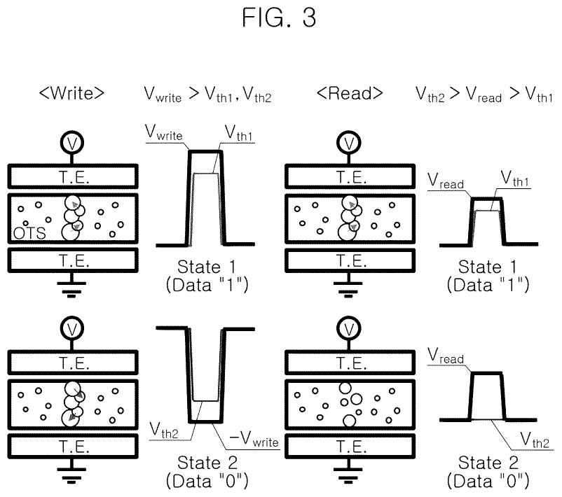

FIG. 3 shows a method and operation examples of resistive change and threshold voltage variation in a chalcogenide-based device in response to a write operation. FIG. 3 shows that whether the chalcogenide-based resistive change device is turned on when a read operation (+ direction) is performed at the same voltage is determined depending on the polarity (+ or − direction) of the pulse applied during the write operation.

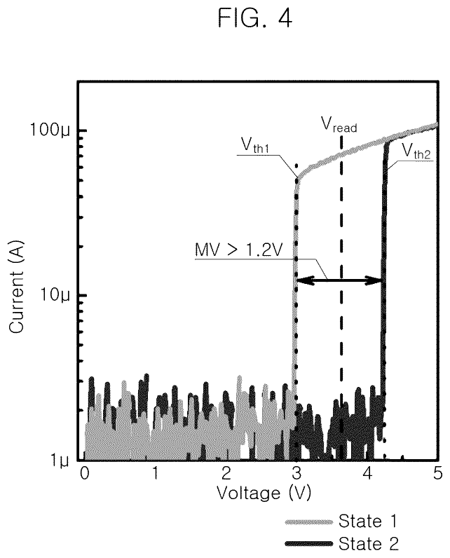

In addition, it may be observed in FIG. 4 that the threshold voltage value of the chalcogenide-based resistive change device varies depending on the polarity of the pulse applied during the write operation.

In other words, the OTS device is characterized in that the threshold voltage varies in subsequent operations depending on the polarity of the applied pulse.

Thus, the present disclosure performs a random write operation by utilizing the inherent dispersion of the OTS during the write process in the negative direction.

Thus, when a write operation is not performed, the OTS has a low threshold voltage, and when a write operation is performed, the OTS has a high threshold voltage.

If a write operation is performed by implementing a cross-bar array with such devices, only some random devices have a high threshold voltage, which the present disclosure may utilize to implement random PUF devices.

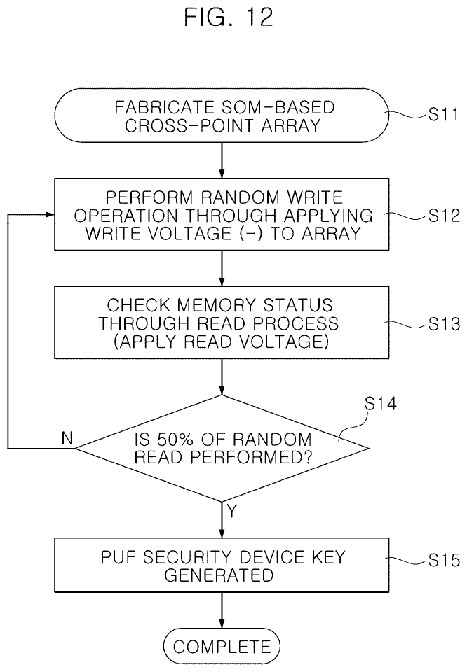

As referenced in FIG. 12, a system on module (SOM)-based cross-point array as shown in FIG. 2 is fabricated (S11), and a write voltage in a negative (−) direction is applied to the array to perform a random write operation (S12).

After the random write operation, memory status is checked through a read process (S13). Then, whether a random read is performed is determined (S14). If a random result of 50%±5% is generated, a suitable PUF security device KEY is considered to have been generated (S15). If a random result of 50%±5% is not generated, the random write operation is performed again (S12).

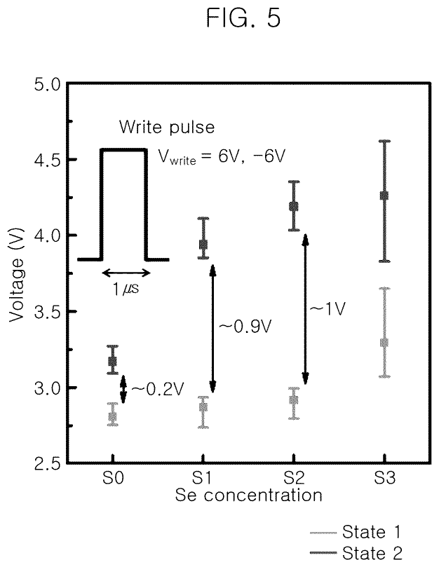

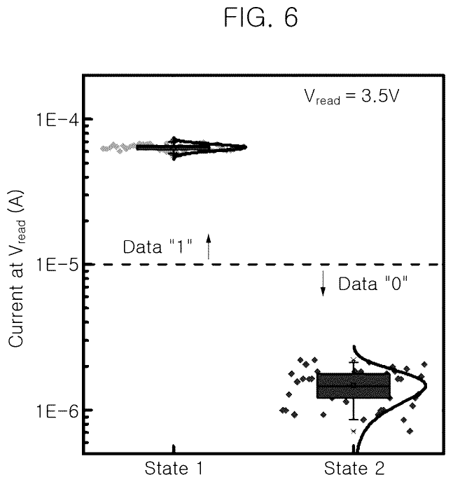

FIG. 5 shows a threshold voltage difference between two states depending on the material composition, and FIG. 6 shows a current at a read voltage.

In other words, as shown in FIG. 5, as a material composition changes, a difference in the OTS threshold voltage occurs depending on the resistance state. The difference in the threshold voltage depending on the resistance state becomes larger as the Se concentration increases.

In addition, it may be observed in FIG. 6 that the current value varies depending on the resistance state of the OTS when a specific read voltage (Vread) is applied.

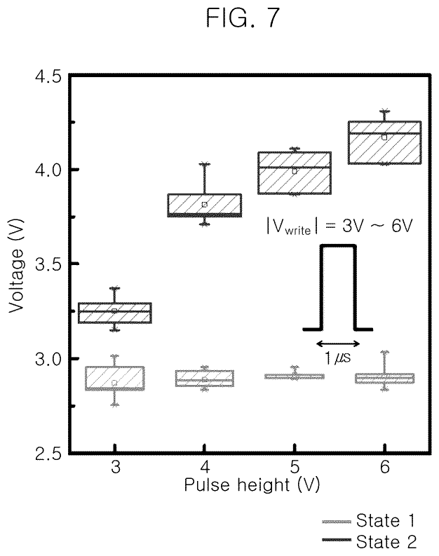

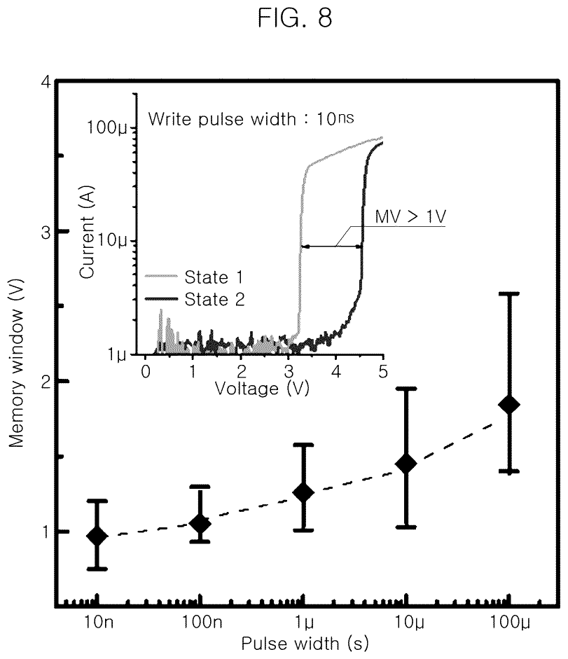

In addition, as shown in FIG. 7, a difference in threshold voltage values depending on the OTS resistance state becomes larger depending on the write pulse height, i.e., a magnitude of the voltage of the write pulse.

Also, as shown in FIG. 8, the threshold voltage difference between the two states becomes larger depending on the write pulse width.

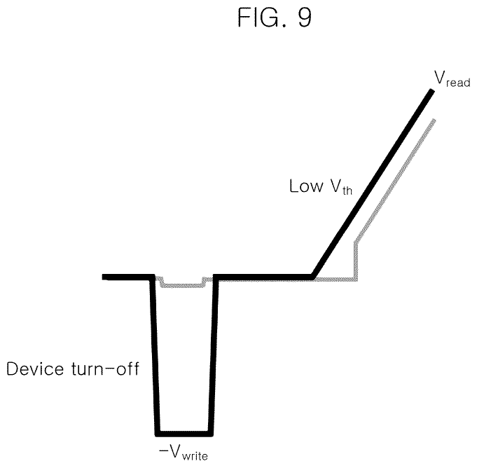

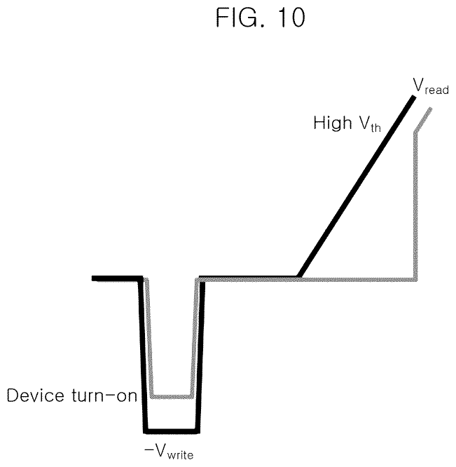

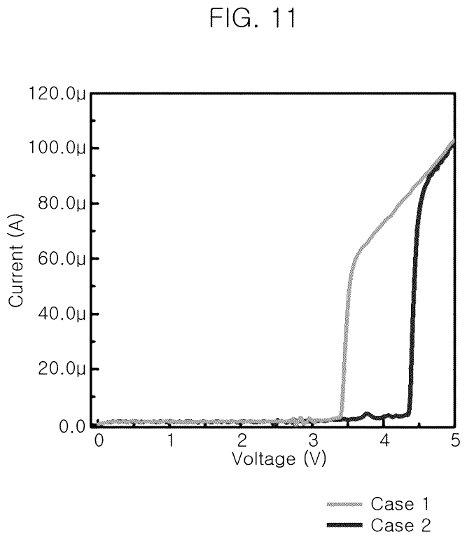

FIGS. 9 and 10 show pulse shapes and operation examples for PUF utilization. FIG. 9 shows a low voltage threshold value (Vth), and FIG. 10 shows a high Vth. FIG. 11 shows an OTS operation example when a pulse is applied for actual PUF utilization.

As described above, if a write operation is performed by implementing a cross-bar array with PUF devices according to the present disclosure, only some random devices have a high threshold voltage, thereby implementing random PUF devices.

Although the present disclosure has been described with reference to the illustrative drawings, the present disclosure is not limited to the embodiments described herein, and it should be apparent to those having ordinary skill in the art that various modifications and variations are possible without departing from the spirit and scope of the present disclosure. Thus, such modifications or variations should fall within the scope of the claims of the present disclosure, and the scope of rights of the present disclosure should be construed based on the accompanying claims.

What is claimed is:

1. A physical unclonable function (PUF) device, comprising:
a plurality of devices having an Ovonic Threshold Switch (OTS) material disposed between a first electrode and a second electrode, wherein the plurality of devices are formed in a cross-bar array structure,
wherein a state in which each device of the plurality of devices has a relatively high threshold voltage value or a relatively low threshold voltage value is randomly generated in response to an identical write pulse being applied to the plurality of devices.

2. The PUF device of claim 1, wherein the OTS material is a chalcogenide material.

3. The PUF device of claim 2, wherein the OTS material is a chalcogenide material comprising selenium (Se).

4. The PUF device of claim 3, wherein the OTS material is at least one material comprising Si—Te—As—Ge—Se, Si—Se—As—Ge, In—Se—As—Ge, Si—In—Se—As—Ge, Se—As—Ge, Ge—Se, B—Se, C—Se, Si—Se, Mg—Se, In—Se, or a combination thereof.

5. The PUF device of claim 2, wherein the OTS material is a compound comprising sulfur(S), selenium (Se), tellurium (Te), polonium (Po), or a combination thereof.

6. The PUF device of claim 1, wherein, in response to an identical read pulse being applied to the plurality of devices, a device of the plurality of devices in a state with a relatively high threshold voltage value is turned on, and a device of the plurality of devices in a state with a relatively low threshold voltage value is turned off.

7. The PUF device of claim 6, wherein the read pulse is a value between the relatively high threshold voltage value and the relatively low threshold voltage value.

8. The PUF device of claim 1, wherein the write pulse is a write voltage in a negative (−) direction.

9. The PUF device of claim 1, wherein the greater a Se concentration in the OTS material is, the greater a difference between the relatively high threshold voltage value and the relatively low threshold voltage value is.

10. The PUF device of claim 1, wherein the greater a magnitude of the write pulse is, the greater a difference between the relatively high threshold voltage value and the relatively low threshold voltage value is.

11. The PUF device of claim 1, wherein the greater a width of the write pulse is, the greater a difference between the relatively high threshold voltage value and the relatively low threshold voltage value is.

12. A method of generating a physical unclonable function (PUF) device, the method comprising:
forming the PUF device of claim 1 in the cross-bar array structure;
performing a random write operation by applying an identical write pulse to the array structure;
applying a read pulse to the array structure;
determining whether the plurality of devices are randomly turned on by the applied read pulse; and
generating a PUF security device KEY if the plurality of devices are randomly turned on.

13. The method of claim 12, wherein when it is determined that the plurality of devices are not randomly turned on in the determining whether the plurality of devices are randomly turned on, the performing the random write operation is re-performed.

14. The method of claim 12, wherein in the determining whether the plurality of devices are randomly turned on, the plurality of devices being turned on is determined to be random if 50%±5% of the plurality of devices are turned on.

15. The method of claim 12, wherein in the performing the random write operation, the write pulse is a write voltage in a negative (−) direction.

16. The method of claim 12, wherein the OTS material is a chalcogenide material.

17. The method of claim 16, wherein the OTS material is a compound comprising sulfur(S), selenium (Se), tellurium (Te), polonium (Po), or a combination thereof.
